(19) United States
(12) Patent Application Publication
(10) Pub. No.: US 2025/0059464 A1
(43) Pub. Date: Feb. 20, 2025

(54) PROCESS FOR PREPARING 'SOAP-FREE', 'SULPHATE-FREE' AND 'GRIT-FREE' SOLID CLEANSING COMPOSITIONS

(71) Applicant: GALAXY SURFACTANTS LTD., Navi Mumbai (IN)

(72) Inventors: Nirmal Koshti, Piscataway, NJ (US); Bhagyesh Jagannath Sawant, Kalyan (IN); Kiran Prakash Gosavi, Dombivli East (IN); Prashant Prabhakar Shirke, Dombivli East (IN); Nitesh Suresh Shinde, Navi Mumbai (IN)

(73) Assignee: GALAXY SURFACTANTS LTD., Navi Mumbai (IN)

(21) Appl. No.: 18/808,963

(22) Filed: Aug. 19, 2024

(30) Foreign Application Priority Data
Aug. 19, 2023 (IN) 202321055642

(51) Int. Cl. C11D 1/28; C11D 3/04; C11D 3/30; C11D 3/33; C11D 3/382; C11D 11/00

(52) U.S. Cl. CPC C11D 1/28; C11D 3/044; C11D 3/30; C11D 3/33; C11D 3/382; C11D 11/0082

(57) ABSTRACT

The invention relates to a process for preparing soap free, sulphate free and grit free solid cleansing composition. The composition has pH resembling to skin pH which comprises ‘non-soap’, ‘non-sulphate’ anionic surfactants and hydrogenated triglyceride oil/s, and optionally, skin benefit agents and/or hair benefit agents. This is accomplished by a unique short and cost-effective process without using any emulsifier or plasticizer. The process entails synthesizing sodium O-acyl isethionates by reacting fatty acid chloride with dry sodium methyl isethionate and sodium isethionate in a sequential manner followed by addition of hydrogenated triglyceride oil. The hot homogeneous paste of sodium O-acyl isethionates and vegetable oils is then flaked. The flakes are then kneaded in a sigma blender where other optional ingredients are mixed. The mass thus obtained is then further refined on a triple roll mill and plodded/extruded into billets or noodles.

### PROCESS FOR PREPARING ‘SOAP-FREE’, ‘SULPHATE-FREE’ AND ‘GRIT-FREE’ SOLID CLEANSING COMPOSITIONS

### FIELD OF INVENTION

The present invention relates to a process for preparing ‘soap free’, ‘Sulphate free’ and ‘grit free’ solid cleansing composition. More particularly, the present invention relates to a process of preparing solid cleansing bars with high vegetable oil (emollient) content. The process of present invention affords ‘grit-free’ solid cleansing bars by extruding a base that is conveniently made by blending hydrogenated vegetable oil with a mixture of sodium O-acyl isethionates.

### BACKGROUND OF THE INVENTION

Conventional soaps bar cakes like sodium or potassium salts of fatty acids, are highly alkaline in nature. The pH of human skin ranges from 5 to 6. The conventional soaps with highly alkaline pH (10 to 11) have harsh action on skin and temporarily change the skin pH which affects the friendly skin microbiota. Also, the harsh nature of soap disturbs the integrity of stratum corneum (and hence the barrier function) by interacting with constituents (proteins, lipids and NMF) of stratum corneum leading to dryness of skin. The problems arising out of high alkalinity of soap are addressed to some extent by synthetic surfactants like sodium lauryl (and cocoyl) sulphate which is available in dry form for solid compositions. However, sulphate-based surfactants with very strong anionic charge are known for denaturing and dissolving protein. The ‘sulphate-type’ anionic surfactants in general compromise the integrity of skin's uppermost layer, the stratum corneum. This leads to dryness (increase in the rate of water loss caused due to weakened stratum corneum) and irritation of the skin. Sulphate based surfactants top the irritancy index and hence the strong attempt/trend in the last decade by the industry was to create cleansers for personal care that are ‘sulphate-free’. This problem due to harshness of soap was addressed by ‘syndet’ bars where part of conventional soap (sodium fatty acid carboxylate) was replaced by sodium cocoyl isethionate. U.S. Pat. No. 2,894,912 (1959) describes ‘Isethionate detergent bar’ which predominantly has sodium cocoyl isethionate, and free fatty acid as binder/plasticizer in addition to a small percentage of conventional soap and water. Typical process involves heating of all ingredients to 100° C. and the hot pasty mass is run through the conventional three roll soap mill followed by extrusion to convert it into billets and finally stamped into bar cakes. Later, the synthetic detergents totally replaced the conventional soap and today, there are several products in the marketplace that can be described as ‘non-soap’ synthetic detergent bars. In these synthetic detergent bars, sodium cocoyl isethionate has been the major anionic detergent along with other synthetic detergents as minor contributors. GB 1294754 (1972) teaches the deployment of synthetic detergents along with fatty acids and fatty alcohols as binders/plasticizers in significant percentage. It also teaches the use of polyethylene glycols of higher molecular weight (˜100,000) along with water for good binding effect. These additional binders are needed, particularly, when emollients like vegetable oils with melting point lower than 45° C. are part of the composition. According to GB'754, emollient oils shouldn't exceed 15% by weight of the total composition since it results in depression of lather, as well as the grittiness in the final bar composition. The grit in the bar mainly results from hard nature of sodium cocoyl isethionate which does not soften enough in the ‘conventional processing’ due to higher percentage of emollient oils present in the composition. It is also reported that the higher percentage of emollient oils (above 15%) can result in ‘cracking’ of the bar cakes.

EP 3,181,114 Al teaches syndet bars containing ‘non-soap’ anionic surfactants with polyglyceryl esters having melting points of 40° C. or less. The polyglyceryl esters of fatty acids are reported to be good binders for the bar cakes, in addition to being lather enhancers. By virtue of being non-ionic in nature, they are also reported to reduce the irritancy potential of anionic surfactants. EP 3,181,114 also teaches that polyglyceryl esters contribute to the ease of manufacturing process (refining/plodding/extrusion).

The polyglyceryl esters of fatty acids with HLB around 6 to 8 have recently been used as emulsifiers in the process of making solid cleansing by Story in U.S. Pat. No. 11,446,216 that teaches compositions comprising (a) a ‘non-soap’ anionic surfactant, (b) a carrier, (c) an emulsifier and (d) water. The process entails preparing an emulsion of the above mentioned four components at elevated temperature using excess water and subjecting the emulsion to cooling and solidification during which the water content is reduced. All examples taught in U.S. Pat. No. 11,446,216 deploy sodium cocoyl isethionate as the major anionic surfactant typically ranging from 37 to 51% by weight of the final composition. In most cases the examples use polyglyceryl-4 palm kernelate (about 4% of the composition) that has the desired HLB value of 8.8. The patent also teaches that the desired HLB number can be achieved by a combination of emulsifiers, for example, polysorbate 20 (HLB of 17) is combined with glyceryl monostearate (HLB of 3.8) to create a combo of with HLB of 8.8. Thus, the composition comprises of an anionic surfactant, water, an emulsifier and an oily phase which is typically, hydrogenated triglyceride vegetable oils present at around 30 to 35% by weight of total composition.

Further US patent application publication 2014/0342974 teaches cleansing bars with O-acyl isethionates (Formula I and Formula II). Incorporation of high % of O-acyl isethionates (Formula I and Formula II) are reported to give slimy feel on the skin after the cleansing. It does not give ‘squeaky clean’ feel post cleansing. This problem is tackled by incorporation of some amount of soap in the formulation. U.S. Pat. No. 20,140,342974A1 teaches a composition comprising of about 60% of O-acyl isethionate and about 15% of O-acyl methyl isethionate and about 10-20% soap and small amount of water. Typically, commercial soap comprises of 75% of sodium salt of fatty acid and the rest is glycerine (15%) and water (10%). Hence, it teaches incorporation of the soap reduces the sliminess of O-acyl isethionates and improves the rinsing ability of the bar cakes.

The problem of ‘grits’ or ‘grittiness’ in the ‘combos’ has been addressed by US patent application 2020/0170914. The combos are cost effective solid cleansers wherein some of the harsh properties of soap are mitigated by incorporating sodium O-acyl isethionates. Typically, in a such combination, soap (sodium salt of fatty acid) is the prominent cleansing surfactant, ranging from 60 to 75%, synthetic surfactant (sodium cocoyl isethionate) is around 15-25% and fatty acids are about 10 to 15% of the total composition. Sodium cocoyl isethionate, being the toughest surfactant in the solid from and with very low solubility/dispersibility in water compared to soap, often results in ‘grit’ formation that is easily perceived by the user during the cleansing operation. This US patent application teaches partial replacement (about one third) of sodium cocoyl isethionate with sodium methyl lauroyl isethionate (sodium O-acyl methyl isethionate) and claims ‘reduced formation’ of the grit and in some cases even total elimination of the grit in a typical composition comprising soap, O-acyl isethionate, and fatty acid. Accordingly, it teaches the uniformity of the composition is achieved by dry-mixing or heating the three constituents, namely, soap, synthetic surfactant and fatty acid.

Hence, prior art teaches different forms of solid cleansing composition, specifically solid cleansing bars that are made from soaps (sodium and potassium salts of fatty acids), combo bars (bars with soap and synthetic surfactants), and synthetic bar (bar completely based on synthetic surfactants) along with vegetable oils and emulsifiers. However, there lies a problem to prepare the solid cleansing compositions that have higher hydrogenated vegetable oils and at the same time free from grits without employing any emulsifier. There also lies a problem of preparing solid cleansing composition that are ‘grit-free’ and involves simple manufacturing steps. There also lies a problem to find a process that involves low utilization of energy and eliminate the step of evaporation of excess water.

The inventors of the present invention have designed a process to overcome the problems of prior art. The inventors of the present invention have, unexpectedly, found that using unique combination of sodium O-acyl isethionates, it is possible to create ‘grit-free’ solid cleansing compositions using very high percentage of hydrogenated vegetables oil without resorting to emulsification process using excess water and a non-ionic emulsifier of specific HLB value and subsequent removal of excess water before extrusion/plodding the material into solid cleansers. The process of present invention reduces the overall time taken for both steps of syndet bar making, namely, a) synthesis of sodium O-acyl isethionates and b) the subsequent processing time to convert ‘isethionate surfactant-oil’ blend (sodium acyl isethionates and hydrogenated vegetable oils) into bar cakes without any process aids such as emulsifiers, binding agents and water.

### OBJECTIVES OF THE INVENTION

It is an objective of the present invention to overcome the limitations of the prior art for making ‘non-soap’ based ‘grit-free’ solid cleansing compositions with high incorporation of vegetable oils.

Another objective of the present invention is to provide a ‘one-pot’ process for making base involving synthesis of sodium O-acyl isethionate surfactants and blending hydrogenated oils in the same pot to afford a ‘grit-free’ solid cleansing base that is amenable to conventional soap extrusion.

Yet, another objective of the present invention is to provide a process for ‘grit-free’ and ‘high oil content’ solid cleansing systems using sodium O-acyl isethionate without resorting to high temperature emulsification process and subsequent concentrating the emulsion by evaporative cooling using special equipment.

Yet another objective of the present invention is to create a process of manufacture that would be amenable to afford ‘grit-fee’, ‘high oil containing’, sodium O-acyl isethionate based solid cleansing systems with pH ranging from 5 to 6, which is similar to skin pH.

Yet further objective of the present invention is to create a process to manufacture ‘high oil containing’ solid cleansing bars with good sensory and lather properties without using any moisturizing agents, binding agents, or plasticizers.

Yet, another objective of the present invention is to create a process for the manufacture of ‘high oil containing’ solid cleansing bars without any non-ionic emulsifier of any specific HLB value.

### SUMMARY OF THE INVENTION

In an aspect, the present invention relates to process for preparing ‘soap-free’, ‘sulphate free’ and ‘grit-free’ solid cleansing composition comprising steps of:
A. preparing mixture of sodium O-acyl isethionate and sodium methyl O-acyl isethionate by reacting a part of acyl chloride with sodium methyl isethionate at 30° C. to 40° C., raising the temperature to 65° C. to 75° C., and adding sodium isethionate to allow consumption of remaining acyl chloride to obtain a reaction mixture;
B. adding hydrogenated triglyceride oil to the reaction mixture of step A to obtain a reaction mass;
C. adding a nitrogenous base to the reaction mass of step B to adjust the pH and afford a viscous reaction mass;
D. flaking the viscous reaction mass obtained in step C, to afford flakes; and
E. kneading the flakes obtained in step D, refining and plodding it, wherein the pH in step C is adjusted in between 4 to 6; and
wherein the plodding temperature is between 38 to 42° C.

In another aspect, the present invention relates to a process for preparing ‘soap-free’, ‘sulphate free’ and ‘grit-free’ solid cleansing composition, the composition comprising:
a. at least 30%, by weight of total composition, a mixture of sodium O-acyl isethionate and sodium methyl O-acyl isethionate; and
b. at least 30%, by weight of total composition, one or more hydrogenated vegetable oil;
   such that the ratio of sodium O-acyl isethionate and sodium methyl O-acyl isethionate is 4:6 to 6:4 and such that melting point of the hydrogenated vegetable oil is at least 45° C.;
   wherein the process comprising steps of:
A. preparing mixture of sodium O-acyl isethionate and sodium methyl O-acyl isethionate by reacting a part of acyl chloride with sodium methyl isethionate at 30°° C. to 40° C., raising the temperature to 65° C. to 75°° C., and adding sodium isethionate to allow consumption of remaining acyl chloride to obtain a reaction mixture;
B. adding hydrogenated triglyceride oil to the viscous reaction mixture of step A to obtain a reaction mass;
C. adding a nitrogenous base to the reaction mass of step B to adjust the pH and afford a viscous reaction mass;
D. flaking the viscous reaction mass of step C to afford flakes; and
E. kneading the flakes obtained in step D, refining and plodding it,
wherein the pH of step C is adjusted between 4 to 6; and
wherein the plodding temperature is between 38 to 42° C.

In yet another aspect, the present invention relates to a ‘soap-free’, ‘sulphate-free’ and ‘grit-free’ solid cleansing composition comprising:
a. at least 30%, by weight of total composition, a mixture of sodium O-acyl isethionate and sodium methyl O-acyl isethionate; and
b. at least 30%, by weight of total composition, one or more hydrogenated vegetable oil;
   such that the ratio of sodium O-acyl isethionate and sodium methyl O-acyl isethionate is 4:6 to 6:4; and
   such that melting point of the hydrogenated vegetable oil is at least 45° C.

The above-described features and the advantages of the present disclosures will be appreciated and understood by those skilled in the art from the ‘detailed description’ and ‘claims’.

### DETAILED DESCRIPTION

The term “soap-free” used herein refers to the composition which does not have any soap component. Soap includes all the salt of a fatty acid or triglyceride oils that are known to person skilled in art. Few representative examples are sodium laurate, potassium laurate, sodium palmate, sodium cocoate, etc.

The term ‘sulphate free’ as used herein refers to composition which is devoid of sulphate-based surfactants that are commonly known in the art. Commonly known sulphate-based surfactants include sodium lauryl sulphate, sodium coco sulphate, ammonium lauryl sulphate, etc.

The term ‘grit-free’ as used herein refers to composition which is devoid of any unsoftened particles of sodium O-acyl isethionates that are commonly referred to as ‘grits’. Grits are tiny particles that provide an unpleasant sandy feeling during use of solid cleansing compositions.

Manufacturing of ‘high oil’ containing solid form (bar cakes/tablets) of personal cleansing composition by emulsifying the oily components (that are solids at or below 45° C.) with water using non-ionic surfactants with HLB value of 6 to 12 is known in the art. The ‘water-in-oil’ type emulsions, described in the prior art, are made at temperature of 90° C. using very high % of water. Typically, the initial quantity of water taken for emulsification is around 25% by weight of the total composition which is made up of ‘soap-free’ surfactant, hydrogenated oil, non-ionic surfactant along with water. This high level of water and the high temperature are needed for proper emulsification and softening of anionic sodium O-acyl isethionate surfactant. The emulsion, thus obtained, is then cooled and solidified with concurrent loss of water to ensure that the final solid composition has minimum 7% water. The hot flowable emulsion is pumped through a needle plate with very fine holes of 0.5 mm mesh. During this process almost 30 to 60% of original water is lost by evaporation resulting in the final content of water to be around 10% of by weight. Emulsifiers taught in the prior art are polyglyceryl-4 palm kernelate, glyceryl monostearate, sorbitan monooleate, and polysorbate 20.

Prior art teaches inclusion of at least 3% of one emulsifier or a combination of emulsifiers resulting in the desired HLB value of 6 to 12 that are based on polyglyceryl esters of fatty acids or ethoxylated sorbitan esters of fatty acids. The triglyceride oil phase has been 16 to 35% of the final composition.

Thus, the process of the prior art involves emulsification of water and oil with non-ionic emulsifiers of a particular HLB value. This process is carried out at high temperatures of 90° C. for long hours after the sodium cocoyl isethionate softens. Commercially available sodium cocoyl isethionate (or sodium lauroyl isethionate) is in the form of needles or flakes and its melting point is around 190-200° C. Hence it is important that every particle of sodium O-acyl isethionate is softened, otherwise the resultant solid cleanser carries unsoftened particles of sodium O-acyl isethionates that are commonly referred to as ‘grits’. The process described in the prior art, although lengthy and cumbersome, ensures ‘grit-free’ solid cleansers. After softening of sodium salts of O-acyl isethionate and emulsification using high temperatures and plenty of water, and the water needs to be removed (30 to 40% of the original quantity) during the process of cooling the mass and converting it into solid form using a special equipment.

The inventors of the present invention have developed a process of preparing ‘grit-free’, ‘sulphate-free’ and ‘soap-free’ solid cleaners without resorting to creating dilute emulsion with lot of water first and then subsequent concentration before the solid mass is made suitable for its conversion into solid cleansers.

The process of the present invention involves simple blending of a mixture of sodium salts of O-acyl isethionates with the hydrogenated triglyceride oils. It not only obviates the step of emulsification involving significant percentage of water, but it totally avoids use of emulsifiers with specific HLB values. The mass of sodium salts of O-acyl isethionates and triglyceride oils produced by the process disclosed in present invention is amenable to conventional solid cleanser processing (soap manufacturing) to deliver ‘grit-free’ bar cakes or any other solid form with pH like skin pH.

The present invention uses ‘one pot’ operation for manufacturing the base for solid cleansers. The ‘one-pot’ process for manufacturing this base involves (a) the synthesis of key anionic surfactant, the sodium salts of O-acyl isethionates and (b) blending hydrogenated triglyceride oil. The syndet base of ‘oil and isethionate’ serves as a chassis for making several variants with optional additives and ‘actives’ using the conventional soap making machinery wherein the optional personal care ‘actives’ are added at the kneading stage where syndet base material is kneaded with other additives and actives in a blender, preferably sigma blender (with ‘Z’ shaped blades that rotate in opposite directions to each other).

Thus, the ‘ready-to-extrude’ syndet base is made in ‘one-pot’ where the sodium O-acyl isethionates are synthesized and blended with hydrogenated vegetable oils. This syndet blend is flaked after adjusting the pH for further processing into bar cakes or other solid form.

### ‘Non-Soap’, ‘Sulphate-Free’ Anionic Surfactants of Solid Cleansing Composition

Preferably, non-soap anionic surfactants (components a.) of the present invention are sodium salts of O-acyl isethionates of Formula I & Formula II that are made by reacting corresponding fatty acid chloride of formula R-COCl, wherein R=C₈ to C₁₈, with dry sodium salts of isethionic acids of Formula III & Formula IV. Fatty acid chloride employed for preparation of O-acyl isethionates is obtained from Galaxy Surfactants Ltd. Mumbai, which manufactures fatty acid chlorides by the ‘Green’ technology (U.S. Pat. 9,308,156). This ‘Green’ technology avoids using toxic formamide type of catalysts are for the chlorination. The ‘Green’ technology is based on the use of totally biodegradable heterogeneous catalyst. This results in the ease of isolation of catalyst from the product (fatty acid chloride) and hence avoiding elaborate purification steps like distillation or crystallization that almost always accompanies with generation of wastage. The ‘Green’ technology also deploys milder chlorinating agent (thionyl chloride) in place of conventional poisonous phosgene.

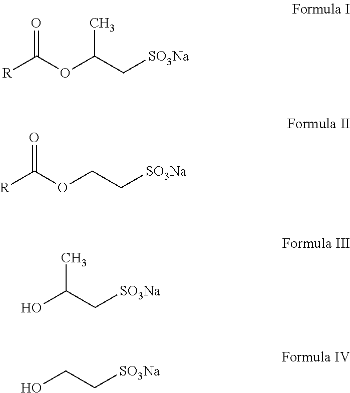

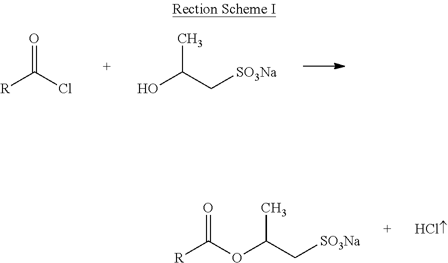

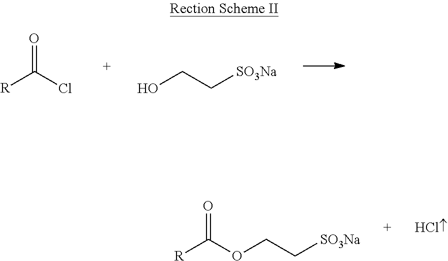

Preferably the cleansing composition of present invention comprises the mixture of sodium O-acyl isethionate and sodium methyl O-acyl isethionate. The mixture of sodium O-acyl isethionate and sodium methyl O-acyl isethionate is selected from mixture of sodium cocoyl isethionate and sodium methyl cocoyl isethionate, mixture of sodium lauryl isethionate and sodium methyl lauryl isethionate or mixture thereof.

Preferably, the process for making ‘grit-free’, ‘soap-free’ and ‘sulphate-free’ solid cleansing compositions involves following five steps. These five steps are further classified in two groups. The first group comprises of Steps A to D that are involved in creation of a syndet base, and the second group comprises of Step E, conventional step of soap manufacturing. The details of the five steps are as follows:
Step A: synthesis of a mixture of sodium O-acyl methyl isethionate and sodium O-acyl isethionate in same pot;
Step B: addition of hydrogenated oil(s) to the mass generated in step A;
Step C: adjustment of pH of the mass of step B;
Step D: flaking the mass of step C to form a ‘syndet base’;
Step E: kneading the ‘syndet base’ of Step D with or without optional ‘additives’ and ‘actives’, refining it on a triple roll mill and plodding/extruding to get syndet bars or solid cleansing bar.

### The Making of Syndet Base

Preferably the making of syndet base of the present invention involves synthesis of sodium O-acyl methyl isethionate of Formula I and sodium O-acyl isethionate of Formula II. Both acyl isethionates are produced in the same pot in the sequential manner from the common fatty acid chloride. In short, part of the fatty acid chloride, preferably about 0.4 to about 0.6 moles, is first reacted with dry powder of sodium methyl isethionate (Formula III), by controlled addition of the powder to a stirred fatty acid chloride at 35 to 40° C. The temperature is raised slowly to 65° C. after completion of addition and the reaction is continued (Step A, Reaction Scheme I and II) for an hour. Nitrogen gas is purged in the reaction mass throughout the course of the reaction. The slow addition of sodium methyl isethionate controls the evolution of hydrogen chloride gas and its efficient absorption in caustic lye solution in a separate scrubbing system. After stirring the mass for one hour, the remainder fatty acid chloride is reacted with dry sodium isethionate (CAS No 1562-00-1, Formula IV) powder by slow addition. After addition of the entire amount of sodium isethionate, the temperature of the reaction mass is raised to 70-75° C. The reaction mass becomes viscous as sodium O-acyl isethionate is formed after an hour. During this last stage of the reaction, part of (˜25% by weight of the total ‘intended’ oil, Examples 1 to 3) the hydrogenated triglyceride oil, component b., (molten form at 60 to 70° C., temperature depending upon the oil or mixture of oils) is added to increase the fluidity of the reaction mass. After stirring the reaction for one hour at 75° C. the remainder hydrogenated triglyceride oil is added in two portions and stirring of the reaction mass is continued for one hour after addition of each instalment (portion) of triglyceride oil (illustrative procedure is described in Examples 1 to 3). Continuous purging of nitrogen through the reaction mass expels most of the hydrogen chloride gas, however, the dissolved hydrogen chloride gas does impart some acidity and that is neutralized by adding nitrogenous bases (liquid in nature) that are commonly used by personal care industry, like mono isopropanol amine (CAS No 78-96-6, Example 1) or tri-isopropanol amine (CAS No 122-20-3, Example 4) or monoethanol amine (CAS No 141-43-5, Example 3) and triethanol amine (CAS No, 102-71-6) etc. The rection mass obtained after complete addition of hydrogenated oil is highly acidic. Such high acidic compositions will lead to skin irritation. Hence, to avoid such irritant effect of composition the pH of the composition is adjusted. Preferably the pH is adjusted in between 4.0 to 6.0. More preferably the pH is adjusted in between 5.0-6.0. The quantity of base to be added is adjusted in such a way that the pH of the reaction mass is between 5.0 to 6.0 when measured on 5% dispersion in water. Further the range of pH can be adjusted to anywhere between 4 to 8 depending upon the end application as in feminine intimate hygiene (acidic pH). Most preferred pH for most skin cleansing applications is around 5.5 (Step D). The hot reaction mass, after adding the base to afford the intended pH, is then flaked on a chilled surface. These flakes (syndet base), mainly comprising of sodium O-acyl isethionates and hydrogenated triglyceride oil, serve as a chassis for creating a variety of solid cleansing offerings with a variety of actives and a few key additives.

Preferably the temperature in Step A during the addition is maintained at 30° C. to 40° C. After the addition of specified quantity of sodium methyl isethionate, the temperature is raised. Preferably the temperature before adding sodium isethionate is maintained between 60° C. to 80° C. Most preferable range of temperature before adding sodium isethionate is 65° C. to 75° C. Preferably the temperature of step B is maintained between 70° C. to 75° C.

### Converting ‘Syndet Base’ Into Solid Cleansing Format

Converting the ‘Syndet Base’ obtained after Step D into final solid cleansing format comprises of Step E outlined above. The ‘Syndet Base’ in the flake form serves as a common chassis and it is then processed on the conventional soap making equipment involving 1) a sigma type blender ('Z′ blades rotating in opposite direction) to knead the material at room temperature or elevated temperature, 2) a triple roll mill required for further refinement of the kneaded mass and 3) a plodder/extruder for converting the solid mass into either pellets, noodles or billets/tablets.

The optional additives (antioxidants, chelating agents, skin care active, hair care active, etc.) are added to the ‘Syndet Base’ at the kneading stage in a sigma blender. Suitably the antioxidants and chelating agents are selected from Etidronic acid, GLDA (L-Glutamic acid, N,N-diacetic acid), citric acid, tetrasodium salt, 2-hydroxy ethyl iminodiacetic acid disodium salt or mixture thereof. Other antioxidant and chelating agents known in art can be added to the composition of present invention. Suitably, the composition includes further optional additives, selected from but not limited to the hair care actives like vitamins, scalp-care agents, anti-dandruff agent, conditioners, UV-protectors, nourishing agents, moisturizing agents, shine/gloss agents, skin-care actives like moisturizers and conditioners, derma purifiers like antimicrobial, anti-acne agents, vitamins, nourishing agents, ceramides. Preferably, the optional additives are added at the kneading stage in a sigma blender.

Preferably, the kneading operations in a sigma blender is typically done at ambient temperature, however, with kneading action a slight increase in temperature of the mass is observed. In some cases, temperature is intentionally raised to 50 to 60° C. by circulating hot water through the jacket of the blender. The ‘kneaded mass’ comprising ‘syndet base’ with additives and actives is then further refined on a triple roll mill and the ‘milled’ mass is extruded plodded keeping the tip (of plodder) temperature at 38-42° C. while taking out the billets for further stamping.

The stamped bar cakes/tablets are analysed for active anionic surfactant content, moisture content, pH (5% dispersion in water), and also for hardness (cone penetrometer), grit and mush (loss of mass due to mushing, gm/50 cm²). The findings are given in the Examples described in the experimental section.

Most illustrative examples (Examples 1 to 6) of the present invention are demonstrated with lauroyl chloride wherein part of lauroyl chloride is converted into sodium lauroyl methyl isethionate (CAS No 928663-45-0), Reaction Scheme 1) first, and then the remainder lauroyl chloride in the same pot is converted sodium lauroyl isethionate (CAS No 7381 Jan. 3, Reaction scheme II). During this synthesis of sodium O-acyl isethionates, a temperature of 65 to 75° C. is maintained. The byproduct of hydrogen chloride gas evolves during the synthesis and is continuously removed by purging nitrogen through the reaction mass. The progress of sodium O-acyl isethionate is monitored by measuring the anionic activity of the mass by titration against a cationic surfactant (Cullum, D. C.; Introduction to surfactant analysis; Chapman & Hall; 1994). When the active matter, based on average molecular weight, is found to be 75% to 80% a part of the hydrogenated oil is added, and reaction is continued at 70-75° C. wherein the added quantity of oil helps maintain the fluidity of the reaction mass without significantly disturbing the polarity of medium enabling the residual reaction to go completion.

By then most of acidity due to evolution of hydrogen chloride gas is removed by increasing the rate of purging nitrogen gas. The residual acidity due to dissolved hydrogen chloride is then neutralized by addition of a base, preferably small molecule amines like monoisopropanol amine (CAS No 78-96-6) (Example 1 and 2) monoethanolamine (CAS No 141-43-5) (Example 3), or triisopropanol amine (CAS No 122-20-3) (Example 4). Basic amino acids (arginine or lysine) (Example 11, L-lysine, 657-27-2) or DL mixture of basic amino acid or inorganic bases can be used to neutralize the residual acidity of blend O-acyl isethionates and hydrogenated triglyceride oil. Very efficient neutralization of acidity of reaction mass and adjusting the pH according to the intended end-application of the solid cleanser can be very conveniently done by bubbling ammonia gas as described in Example 12. Neutralizing acidity is easy with liquid small molecular weight amines that are widely used in personal care industry like monoethanol amine, mono isopropanol amine or triethanol amine. Tri isopropyl amine is a low melting solid (48-52° C.) that can be added as such in Step C or it can be molten and added to the reaction mass. In case of L-lysine, which exists as a solid, is added in Step C (Example 11). Bubbling ammonia gas (Example 12) is equally convenient as compared to low molecular weight amines.

A person skilled in the art would understand that other alkali metal ions like potassium or ammonium ions can be used while making salts of isethionic acid in place of sodium as alkali metal counter ion of O-acyl isethionates. It is also known to those who are skilled in the art that acyl halides can be reacted with other hydroxy terminated short chain (3 to 4 carbon, linear or branched) sulphonic acids salts, for example, sodium hydroxy propyl sulphonate or sodium hydroxybutyl sulphonate. As regards to acyl chloride for synthesizing O-acyl isethionates, acyl chain can be of one single fatty acid, or it can be of a mixture of several fatty acids. Some of the vegetable oil derived fatty acids have unsaturated fatty acids and corresponding acid chlorides can be selected (for example oleoyl chloride) to make O-acyl isethionates. An example of mix fatty acid chloride is cocoyl chloride and Example 7 describes the making of corresponding sodium O-acyl isethionates.

Cocoyl chloride is a mixture of several fatty acid chlorides ranging from C₈ to C₁₆ acid chlorides and % alkyl chain distribution is given experimental section which shows that C₁₂ alkyl chain component is the most prominent (˜55-60%), corresponding to natural distribution of coconut oil. The reaction between cocoyl chloride and sodium salts of isethionic acid results in corresponding sodium cocoyl methyl isethionate (CAS No 2244880-58-6) and sodium cocoyl isethionate (CAS No 61789-32-0) which are subsequently blended with hydrogenated soyabean oil in Example 7. Hydrogenated sunflower oil replaces hydrogenated soyabean oil in Example 8 with above mentioned cocoyl isethionates.

Hydrogenated vegetable oils of the present invention can be one or it can be a combination of more than one hydrogenated triglyceride oils. Most commonly used oils, for the solid cleansers, are hydrogenated soyabean seed oil and hydrogenated sunflower seed oil. Hydrogenated triglyceride oils with melting point above 45° C. are most suitable. Rapeseed oil, olive oil, coconut oil, palm oil or palm kernel oil are widely produced oils and their hydrogenated versions, fully saturated forms, can be selected for the solid cleansers of the present invention. Oils with higher % of long fatty acids (above C₁₈ to C₂₂) have higher melting point and they are suitable for solid cleansing forms of the present invention. Example 2 is demonstrated with higher % (˜60%) of hydrogenated soyabean oil compared to other examples wherein the ratio of anionic surfactants to triglyceride oil is approximately 6:4. Since oil content of the composition of Example 2 is higher, the corresponding active content as anionic surfactant is lowered. Further the oils used are chemically treated i.e. the hydrogenated oil. The molar ratio of sodium O-lauroyl methyl isethionate to sodium O-lauroyl isethionate in Examples 1 to 4 is 1:1. However, equally good syndet base material is obtained by changing the molar ratio of these two O-acyl isethionates as exemplified in Example 5 wherein the molar ratio of sodium O-lauroyl methyl isethionate to sodium O-lauroyl isethionate is 6:4 and in Example 6 it is 4:6. Increase in sodium O-acyl methyl isethionate relative to sodium O-acyl isethionate as in molar ratio of 7:3 results in softer base that is difficult to process to convert it into solid format with the desired hardness. On the other hand, if sodium O-acyl methyl isethionate is lowered relative to sodium O-acyl isethionate as in the ratio of 3:7 then the base becomes hard with some presence of grits. Hardness and the presence of grit can be overcome by extra processing time but that often times is quite abnormally long.

The hardness is measured by cone penetrometer and the grit determination or wet-bar feel test is assessed by the protocol given in the experimental. Hardness of the end solid cleanser has a bearing on the ‘mush’ which is again measured as loss of mass in grams/50 cm² after keeping the bar cake in water for certain period (3 hr) of time at 25° C. Typically, hard bar cake has less mush. But by the same token, very hard material often shows significant presence of grits.

Most examples show hardness numbers between 9 to 11 and mush value of 7 to 11gm/50 cm². Thus, for the compositions of the present invention the molar ratio of acyl isethionates of Formula I and Formula II is selected from 4:6 to 6:4. The ‘Syndet Base’ thus obtained with hydrogenated vegetable oil and the blend of sodium O-acyl isethionates affords a chassis for creating variants with specific actives for specific applications. For example, syndet base (step D) is processed in a sigma blender along with a chelating agent (GLDA, L-Glutamic acid, N,N-diacetic acid, tetrasodium salt CAS No 51981-21-6, 2-hydroxy ethyl iminodiacetic acid disodium salt, CAS No 93-62-9) and tocopherol acetate as an antioxidant in Example 9. In addition to these additives, the composition of Example 9 has undecylenoyl glycine (CAS No 54301-26-7) as an antibacterial antidandruff agent and polyglyceryl-4 laurate as foam booster and moisturizer. The solid composition of Example 10 has Etidronic acid (1-hydroxyethane 1,1-diphosphonic acid disodium salt) as chelating agent and an anti-oxidant and capryloyl glycine (CAS No 14246-53-8) as an anti-bacterial anti-acne agent. Several other chelating agents like sodium gluconate or citric acid can be added to the ‘syndet base’ during kneading stage of the step E. Similarly, any skin active or hair-active can be included at this stage of kneading. Depending upon the thermolability of the active ingredients the temperature of sigma type blender is adjusted to speed up the process.

Both O-acyl isethionates (sodium O-acyl methyl isethionate and sodium O-acyl isethionate) and hydrogenated vegetable oil form a uniform homogeneous pasty mass only if it is produced in the way described herein and illustrated in Examples 1 to 12. It is important that the dispersion of surfactants and saturated oil is suitable for extruding, and the extruded form should be totally ‘grit-free’ as illustrated in Examples 1 to 12.

Preferably the component a. i.e., mixture of sodium O-acyl isethionate and sodium methyl O-acyl isethionate, is present in an amount of at least 30% by weight of the solid cleansing composition. The mixture of sodium O-acyl isethionate and sodium methyl O-acyl isethionate is present in an amount of 30% or more than 30% by weight of solid cleansing composition. Preferable ratio of the mixture of sodium O-acyl isethionate and sodium methyl O-acyl isethionate is between 4:6 and 6:4. The mixture of sodium O-acyl isethionate and sodium methyl O-acyl isethionate is preferably selected from mixture of sodium cocoyl isethionate and sodium methyl cocoyl isethionate, mixture of sodium lauryl isethionate and sodium methyl lauryl isethionate or mixture thereof. Preferably the mixture of sodium O-acyl isethionate and sodium methyl O-acyl isethionate is present in an amount of up to 50% by weight of the solid cleansing composition.

Preferably component b. i.e., hydrogenated vegetable oil is present in an amount of at least 30% by weight of the solid cleansing composition. Preferably hydrogenated vegetable oil is present in an amount of 30% or more than 30% by weight of solid cleansing composition. One or more hydrogenated vegetable oil is preferably selected from hydrogenated soyabean oil, hydrogenated sunflower oil, hydrogenated rapeseed oil, hydrogenated olive oil, hydrogenated coconut oil, hydrogenated palm oil, hydrogenated palm kernel oil or mixture thereof. Preferably hydrogenated vegetable oil is present in an amount up to 65% by weight of the solid cleansing composition.

Preferably the solid cleansing composition comprises component a. and component b. in an amount of at least 90% of the solid cleansing composition. The solid cleansing composition comprises component a. and component b. in an amount of up to 100% by weight of the solid cleansing composition.

The product obtained after flaking step D is regarded as the solid cleansing composition of the present invention. Preferably flaking is carried out onto the cold surface. However, it can be carried out onto other techniques that are known in art. The flaked solid cleansing composition can be further processed and may include the additives to form the final billets/tablets or the flaked composition can be converted into powder by suitable size reduction apparatus, for example a kitchen blender, to obtain the solid cleansing composition in powder form.

Comparative Example A demonstrates that simply heating of sodium lauroyl isethionate alone (powder, particle size <400μ) with hydrogenated oil and then flaking and kneading with water as described, does not yield a mass that is amenable to plodding. In another experiment (Comparative Example B), both sodium lauroyl isethionate and sodium lauroyl methyl isethionate, in powder form (particle size <400μ), are processed together with hydrogenated soyabean oil. This results in a material suitable for extrusion after kneading it with water at elevated temperature 70-80° C. in a sigma blender and then further refining. However, the final billets are full of grits. Any role of the amines for getting surfactants uniformly dispersed in hydrogenated oil is ruled out after conducting the experiment as described in Comparative Example C.

The problem of ‘grits’ or ‘grittiness’ in the ‘combos’ has been addressed by US 2020/0170914. The combos are cost effective solid cleansers wherein some of the harsh properties of soap are mitigated by incorporating sodium O-acyl isethionates. Typically, in a such combination, soap (sodium salt of fatty acid) is the prominent cleansing surfactant, ranging from 60 to 75%, synthetic surfactant (sodium cocoyl isethionate) is around 15-25% and fatty acids are about 10 to 15% of the total composition. Sodium cocoyl isethionate, being the toughest surfactant in the solid form and with very low solubility/dispersibility in water compared to soap, often results in ‘grit’ formation that is easily perceived by the user during the cleansing operation. This US patent application teaches partial replacement (about one third) of sodium cocoyl isethionate with sodium methyl lauroyl isethionate (sodium O-acyl methyl isethionate) and claims ‘reduced formation’ of the grit and in some cases even total elimination of the grit in a typical composition comprising soap, O-acyl isethionate, and fatty acid. Accordingly, it teaches, the uniformity of the composition is achieved by dry-mixing or heating the three constituents, namely, soap, synthetic surfactant and fatty acid. This approach of creating ‘grit-free’ solid compositions doesn't work in ‘non-soap’ and ‘high vegetable oil’ containing systems that are largely anhydrous. The comparative Example B illustrates admixing (amalgamating) of hydrogenated vegetable oil, sodium lauroyl isethionate and sodium lauroyl methyl isethionate in anhydrous system. The admixture, despite high temperature, the seemingly homogeneous nature doesn't afford ‘grit-free’ base and it is found to be not suitable to further conventional processing (sigma blending, refining and extrusion) into cleansing bar.

The other instance in the prior art wherein both types of O-acyl isethionates (Formula I and Formula II) are used in ‘combo’ cleansing bars in 2014 (US 20140342974A1). Very high % of O-acyl isethionates (Formula I and Formula II) are reported to give slimy feel on the skin after the cleansing. It does not give ‘squeaky clean’ feel post cleansing. This problem is tackled by incorporation of some amount of soap in the formulation. Typical formula of US 20140342974A1 contains 60% of O-acyl isethionate and 15% of O-acyl methyl isethionate and 10-20% soap and small amount of water etc. Typically, commercial soap comprises of 75% of sodium salt of fatty acid and the rest is glycerine (15%) and water (10%). Incorporation of the soap reduces the sliminess of O-acyl isethionates and improves the rinsing ability of the bar cakes. Thus, it should be noted that two situations with ‘combo’ bars have been reported wherein O-acyl isethionate combinations of Formula I and Formula II are used with soap, one with high soap and low O-acyl isethionates and the other with high O-acyl isethionates and low soap. However, both the prior art teaches the composition without incorporation of hydrogenated oils. Hydrogenated oil imparts the moisturizing effect to the skin after the cleansing process. Often times, harsh alkaline soaps and harsh anionic surfactants wash out the essential fatty substance of skin, that leads to dryness and itchy skin surface after cleansing process. Incorporation of oils and replacing of harsh anionic surfactants with milder anionic surfactants like acyl-isethionate can prevent the dryness after the cleansing activity. However, the direct incorporation of oils into the O-acyl isethionates results into grit formation and hence, there is requirement of formation of emulsification which ultimately requires addition of emulsifiers. However, present investors have found out a composition and a process that allows higher incorporation of hydrogenated oils without requirement of incorporation of emulsifiers.

Conventional processes of the prior art rely on using sodium O-acyl isethionate made from fatty acid which is hard substance with a melting point of around 200° C. O-acyl isethionates of 80 to 90% purity are manufactured from fatty acids and salts of isethionic acids by effecting esterification reaction at 180 to 210° C. The high temperature is necessary because only at that temperature reaction mass can be stirred to push the reaction to achieve more than 80% conversion into ester-salts. The sodium salt of O-acyl isethionates that are available commercially as pellets, noodles or flake are tough material (hard solids) that is difficult to hydrate. While formulating O-acyl isethionates in cleansing formulations, either liquid or solid, they need to be softened enough to disperse, dissolve or to emulsify to get ‘grit-free’ formulation (Soap manufacturing technology, edited by Luis Spitz, second edition 2016, Academic press with AOCS press, page 138 (This page refers to a chapter titled ‘Formulation of Traditional Soap Cleansing systems’ by Edmund George and David Raymond). However, the process of the present invention obviates-
a) a need for high temperature synthesis of sodium O-acyl isethionates since these are produced at very low temperatures unlike the process in the prior art where it is produced from fatty acid at temperatures that are upwards of 180° C. and
b) a need for extensive cooking/softening of sodium O-acyl isethionates while formulating and hence it can be mixed with the other ingredients like hydrogenated vegetable oils to get a homogeneous mass for further processing and converting in to grit-less solid cleansing system.

Thus, the process of present invention allows one pot generation of ‘grit-free’ base material for extrusion wherein both, the synthesis of O-acyl isethionate at very low temperature (65 to 70° C.) and the homogeneous blending of other major ingredients at same temperature is possible. The current process obviates the need for conventional high temperature chemistry (sod. O-acyl isethionates) that is accompanied by thermal decomposition/degradation products. For example, dehydration of sodium isethionate in esterification with fatty acid at 180 to 200° C. (EP 0594297, David Tracy, Gordon Wall and M. B. Ferguson, 1996) as shown in the equation below.

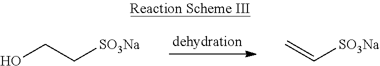

Formation of sodium vinyl sulphonate (reaction scheme III) is the result of high temperature induced dehydration of sodium isethionate. The process of preparing solid cleansers of the present invention also obviates the need for emulsification with large amount of water and then subsequent removal of water post emulsification with high content of vegetable oil as carrier using additional emulsifiers. In general, it obviates the need for any cooking/softening of sodium acyl isethionate to make final cleansers totally ‘grit-free’. Thus, the process of the present invention avoids both special equipment as well as additional processing aids to make material uniform and grit-free.

The ‘one-pot’, ‘grit-free’ creation of ‘non-soap’, ‘sulphate-free’ syndet base is possible due to specifically designed process with the five steps that are executed in the given order.

Finally, the base material generated in the ‘one pot-process’ is amenable to the pH adjustment and cleanser with skin pH that delivers creamy lather with gentle cleansing can be produced. Also, the heat-sensitive actives or additives can be added conveniently and could be cold-mixed at kneading stage of Step E. Finally, no operation needs temperature of more than 75° C. The design and execution of synthesis keeps the sodium salts of O-acyl isethionates malleable at 70-75° C. The material produced in all the Examples is converted into bar cakes/tablets by conventional soap making equipment and are found to be of desired hardness and mush.

The invention is now described by way of non-limiting illustrative examples.

### EXAMPLES

Sodium lauroyl isethionate (Galsoft SLI P (85% active) in powder form, particle size less than 400 u) and sodium lauroyl methyl taurate (in powder form, Galsoft SLT-P (90% active, particle size less than 400μ) are supplied by Galaxy Surfactants Ltd. Mumbai, India. Sodium lauroyl 2-methyl isethionate is synthesized as per the procedure given in WO1994009763A1 and pulverized into fine powder with particle size of less than 400μ. Sodium isethionate and sodium methyl isethionate in powder form are procured from Aldrich.

Lauroyl chloride and cocoyl chloride are supplied by Galaxy Surfactants Ltd.

Mush of the final bar cakes/tablet is determined by the protocol of ‘tablet immersion test’ as described in IS 13498:1997 of Bureau of Indian Standards. Mush is measured as loss of mass in gram per 50 cm² of the bar cake that is immersed in water for 2.5 hrs at 25° C. hours at ambient temperature.

Hardness of the bar cakes/tablets is measured by cone penetrometer as per ASTM D459.

Grit or grittiness/sandiness or wet-bar feel of bar cake/tablets is evaluated as per the standard industry protocol described on page 424 of a chapter on ‘Soap Bar Performance Evaluation Methods’ by Yury Yarovoy and Albert Post in the book titled ‘Soap Manufacturing Technology’ Luis Spitz, second edition 2016, Academic press with AOCS press.

Hydrogenated soyabean oil and hydrogenated sunflower oil are procured from AAK India Pvt Ltd as such. None of these hydrogenated triglyceride oils are produced by Galaxy Surfactants Ltd. (applicant) rather they are procured as hydrogenated products as such from the above-mentioned supplier.

### Comparative Example A

To a stirred molten mass of hydrogenated soyabean seed oil (648 g, 0.78 gmol) at 85-90° C. under nitrogen blanket, sodium lauroyl isethionate powder (540 g 1.3 gmol, particle size less than 400μ) is added and agitation is continued for 4 h. The homogeneous slurry is flaked on a cold surface. The thin flakes are then treated with water (36 g 2.0 gmol, 3.0% of the total mass) in a SIGMA blender at 70-80° C. for three hours and then refined on a TRM (triple roll mill) and followed by a duplex plodder to convert into billets. Here the syndet bar comprises only sodium lauroyl isethionate and the syndet base is prepared without inclusion of sodium lauryl methyl isethionate. However, it is observed that the material is not amenable to plodding due to its powdery nature. Hence, the use of only sodium lauroyl isethionate powder, that is readily available, does not form the product required. Making the solid cleansing composition with only sodium lauroyl isethionate required addition of emulsifiers and further requires emulsification steps as described in prior art which includes water as well.

### Comparative Example B

To a stirred molten mass of hydrogenated soya oil (756 g, 0.91 gmol) at 85-90° C. under nitrogen blanket, sodium lauroyl isethionate powder (308 g, 0.75 gmol), particle size less than 400 u), sodium lauroyl methyl isethionate powder (322 g, 0.75 gmol, particle size less than 400μ), are added and agitation is continued for 4 h. The homogeneous slurry is flaked on a cold surface. The thin flakes are then treated with water (54 g, 3.0 gmol, 4% of the total mass) in a SIGMA blender at 70-80° C. for three hours and then refined on a TRM (triple roll mill) and followed by a duplex plodder to convert into billets at 40° C. The billets are then stamped into cleansing bars. However, it is observed during cleansing operation (washing hands) that the bars are full of grits. Hence, the physical mixing of hydrogenated vegetable oil, sodium lauryl isethionate and sodium lauryl methyl isethionate, separately, does not work, and it provides the final solid cleansing composition that is full of grits.

### Comparative Example C

To a stirred molten mass of hydrogenated soya oil (756 g, 0.91gmol) at 85-90° C. under nitrogen blanket, sodium lauroyl isethionate powder (308 g, 0.75 gmol, particle size less than 400μ), sodium lauroyl methyl isethionate powder (322 g, 0.75 gmol, particle size less than 400 u), are added and agitation is continued for 4 h. To this mass, monoisopropanol amine (10 g, 0.13 gmol) is added and the agitation is continued for an additional two hours. The homogeneous slurry is flaked on a cold surface. The thin flakes are then crushed in a SIGMA blender at 70-80° C. for three hours and then refined on TRM (triple roll mill) and followed by a duplex plodder to convert into billets at 40° C. However, it is observed that this mass is not suitable for converting into billets. Further, the physical mixing of hydrogenated vegetable oil, sodium lauryl isethionate and sodium lauryl methyl isethionate along with the nitrogenous base (monoisopropanol amine) does not work and provides the final solid cleaning bar that is full of grits as observed in comparative example

B. This rules out the role of nitrogenous base for uniform dispersion of surfactant components in hydrogenated oil component.

### Example 1

To stirred lauroyl chloride (356 g, 1.6 gmol) at 35-40°° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 550 g) is added and agitation is continued for an additional one hour. This is followed by addition of the rest of the hydrogenated soyabean oil (410 g, 0.5 gmol) in two portions (205 g+205 g) and stirring of the mix is continued for additional two hours (1h stirring after each portion of oil) at 70-75° C. with continuous nitrogen purging. Acidity of the material is neutralized by addition of monoisopropanol amine (14 g, 0.18 gmol) to achieve pH of 5% dispersion between 5.0 to 6.0.

The ‘pH adjusted’ hot material is flaked (1085 g) on a cold surface and subsequently, kneaded in a sigma blender (with Z type sigma blades that rotate in opposite directions to each other) at 60-65° C. for 3 hours and finally refined using a triple roll mill and a duplex plodder (38-42° C.) to get the final billets for stamping.

TABLE 1
Analysis of the bar cake of Example 1:

| | |
|---|---|
| Moisture | 2.65% |
| pH (5% dispersion in water) | 5.56 |
| Active matter as anionic surfactant, (MW 337) | 38.2% |
| Chloride ion (Cl⁻) content | 1.2% |
| Hardness | 9-10 |
| Grit | Absent |
| Mush | 7.25 g/50 cm² |

### Example 2

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (20% of the total 738 g) is added and agitation is continued for an additional one hour. This is followed by addition of the rest of the hydrogenated soyabean oil (598 g, 0.72 gmol) is added in two portions (299 g+299 g) and stirring of the mix is continued for additional two hours (one hour stirring after each portion of oil) at 70-75° C. with continuous nitrogen purging. Acidity of the material is neutralized by addition of monoisopropanol amine (14 g, 0.18 gmol) to achieve pH of 5% dispersion between 5.0 to 6.0.

The ‘pH adjusted’ hot material is flaked (1300 g) on a cold surface and subsequently, kneaded with water (20 ml) in a sigma blender (with Z type sigma blades that rotate in opposite directions to each other) at 60-65° C. for 3 hours and finally refined using a triple roll mill and a duplex plodder (38-42° C.) to get the final billets for stamping.

TABLE 2
Analysis of the bar cake of Example 2:

| | |
|---|---|
| Moisture | 4.60% |
| pH (5% dispersion in water) | 5.8 |
| Active matter as anionic surfactant, (MW 337) | 35.20% |
| Chloride ion (Cl⁻) content | 1.72% |
| Hardness | 9-10 |
| Grit | Absent |
| Mush | 6.5 g/50 cm² |

### Example 3

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 550 g) is added and agitation is continued for an additional one hour. This is followed by addition of the rest of the hydrogenated soyabean oil (410 g, 0.5 gmol) is added in two portions (205 g+205 g) and stirring of the mix is continued for additional two hours (one hour stirring after each portion of oil) at 70-75° C. with continuous nitrogen purging. Acidity of the material is neutralized by addition of monoethanol amine (12 g, 0.19 gmol) to achieve pH of 5% dispersion between 5.0 to 6.0.

The ‘pH adjusted’ hot material is flaked (1098 g) on a cold surface and subsequently, kneaded with water (16ml) in a sigma blender (with ‘Z’ type sigma blades that rotate in opposite directions to each other) at 60-65° C. for 3 hours and finally refined using a triple roll mill and a duplex plodder (38-42° C.) to get the final billets for stamping.

TABLE 3
Analysis of the bar cake of Example 3:

| | |
|---|---|
| Moisture | 2.65% |
| pH (5% dispersion in water) | 6.0 |
| Active matter as anionic surfactant, (MW 337) | 39.2% |
| Chloride ion (Cl⁻) content | 1.37% |
| Hardness | 9-10 |
| Grit | Absent |
| Mush | 7.0 g/50 cm² |

### Example 4

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 547 g) is added and agitation is continued for an additional one hour. This is followed by addition of the rest of the hydrogenated soyabean oil (410 g, 0.5 gmol) is added in two portions (205 g+205 g) and stirring of the mix is continued for additional two hours (1h stirring after each portion of oil) at 70-75° C. with continuous nitrogen purging. Acidity of the material is neutralized by addition of molten triisopropanol amine (28 g, 0.16 gmol, melts at 50° C.) to achieve pH of 5% dispersion between 5.0 to 6.0.

The ‘pH adjusted’ hot material is flaked (1075 g) on a cold surface and subsequently, kneaded in a sigma blender (with Z type sigma blades that rotate in opposite directions to each other) at 60-65° C. for 3 hours and finally refined using a triple roll mill and a duplex plodder (38-42° C.) to get the final billets for stamping.

Analysis of the bar cake:

| | |
|---|---|
| Moisture | 2.4% |
| pH (5% dispersion in water) | 5.8 |
| Active matter as anionic surfactant, (MW 337) | 39.35% |
| Chloride ion (Cl⁻) content | 1.38% |
| Hardness | 9-10 |
| Grit | Gritless |
| Mush | 7.30 g/50 cm² |

### Example 5

To stirred lauroyl chloride (356 g, 1.6 gmol) at 35-40° C. and with nitrogen purging (bubbling through the reaction mass), sodium methyl isethionate (powder, 159g, 0.96 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 97 g, 0.64 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 550 g) is added and agitation is continued for an additional one hour. This is followed by addition of the rest of the hydrogenated soyabean oil (410 g, 0.5 gmol) is added in two portions (205 g+205 g) and stirring of the mix is continued for additional two hours (1h stirring after each portion of oil) at 70-75° C. with continuous nitrogen purging. Acidity of the material is neutralized by addition of monoisopropanol amine (14 g, 0.18 gmol) to achieve pH of 5% dispersion between 5.0 to 6.0.

The ‘pH adjusted’ hot material is flaked (1102 g) on a cold surface and subsequently, kneaded in a sigma blender (with Z type sigma blades that rotate in opposite directions to each other) at 60-65° C. for 3 hours and finally refined using a triple roll mill and a duplex plodder (38-42° C.) to get the final billets for stamping.

TABLE 5
Analysis of the bar cake of Example 5:

| | |
|---|---|
| Moisture | 2.6% |
| pH (5% dispersion in water) | 5.45 |
| Active matter as anionic surfactant, (MW 337) | 38.4 |
| Chloride ion (Cl⁻) content | 1.18% |
| Hardness | 11-12 |
| Grit | Absent |
| Mush | 7.5 g/50 cm² |

### Example 6

To stirred lauroyl chloride (356 g, 1.6 gmol) at 35-40° C. and with nitrogen purging (bubbling through the reaction mass), sodium methyl isethionate (powder, 110g, 0.66 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 145 g, 0.95 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 552 g) is added and agitation is continued for an additional one hour. This is followed by addition of the rest of the hydrogenated soyabean oil (410 g, 0.5 gmol) is added in two portions (205 g+205 g) and stirring of the mix is continued for additional two hours (1h stirring after each portion of oil) at 70-75° C. with continuous nitrogen purging. Acidity of the material is neutralized by addition of monoisopropanol amine (12 g, 0.16 gmol) to achieve pH of 5% dispersion between 5.0 to 6.0.

The ‘pH adjusted’ hot material is flaked (1007 g) on a cold surface and subsequently, kneaded with water (15ml) in a sigma blender (with Z type sigma blades that rotate in opposite directions to each other) at 60-65° C. for 3 hours and finally refined using a triple roll mill and a duplex plodder (38-42° C.) to get the final billets for stamping.

TABLE 6
Analysis of the bar cake of Example 6:

| | |
|---|---|
| Moisture | 3.8% |
| pH (5% dispersion in water) | 6.0 |
| Active matter as anionic surfactant, (MW 337) | 39.42 |
| Chloride ion (Cl⁻) content | 1.28 |
| Hardness | 8-9 |
| Grit | Absent |
| Mush | 6.5 g/50 cm² |

### Example 7

Cocoyl chloride with the below mentioned alkyl chain distribution is employed in this example.

Cocoyl chain distribution: C₈; 6%, C₁₀; 6%, C₁₂; 60%, C₁₄; 20%, C₁₆; 7.0%, and C₁₈; 1.0%.

To stirred cocoyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder cocoyl chloride. To this viscous slurry at 70-75° C., under continuous nitrogen purging to expel hydrogen chloride gas, part of hydrogenated soyabean oil (140 g, 0.17 gmol (25% of the total 550 g) is added and agitation is continued for an additional one hour. This is followed by addition of the rest of the hydrogenated soyabean oil (410 g, 0.5 gmol) is added in two portions (205 g+205 g) and stirring of the mix is continued for additional two hours (1h stirring after each portion of oil) at 70-75° C. with continuous nitrogen purging. Acidity of the material is neutralized by addition of monoisopropanol amine (12 g, 0.16 gmol) to achieve pH of 5% dispersion between 5.0 to 6.0.

The ‘pH adjusted’ hot material is flaked (1075 g) on a cold surface and subsequently, kneaded with water (20 ml) in a sigma blender (with Z type sigma blades that rotate in opposite directions to each other) at 60-65° C. for 3 hours and finally refined using a triple roll mill and a duplex plodder (38-42° C.) to get the final billets for stamping.

TABLE 7
Analysis of the bar cake of Example 7:

| | |
|---|---|
| Moisture | 5.40% |
| pH (5% dispersion in water) | 5.73 |
| Active matter as anionic surfactant, (MW 337) | 41.68% |
| Chloride ion (Cl⁻) content | 1.39% |
| Hardness | 9-10 |
| Grit | Absent |
| Mush | 7.9 g/50 cm² |

### Example 8

To stirred lauroyl chloride (200 g, 0.9 gmol) at 35-40° C. and with nitrogen purging (bubbling through the reaction mass), sodium methyl isethionate (powder, 82 g, 0.49 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 68 g, 0.45 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated sunflower oil (82 g, 0.1 gmol (of the total 326 g) is added and agitation is continued for an additional one hour. This is followed by addition of the rest of the hydrogenated sunflower oil (244 g, 0.29 gmol) is added in two portions (122 g+122 g) and stirring of the mix is continued for additional two hours (1 h stirring after each portion of oil) at 70-75° C. with continuous nitrogen purging. Acidity of the material is neutralized by addition of monoisopropanol amine (10 g, 0.13 gmol) to achieve pH of 5% dispersion between 5.0 to 6.0.

The ‘pH adjusted’ hot material is flaked (600 g) on a cold surface and subsequently, kneaded in a sigma blender (with Z type sigma blades that rotate in opposite directions to each other) at 60-65° C. for 3 hours and finally refined using a triple roll mill and a duplex plodder (38-42° C.) to get the final billets for stamping.

TABLE 8
Analysis of the bar cake of Example 8:

| | |
|---|---|
| Moisture | 3.4% |
| pH (5% dispersion in water) | 5.45% |
| Active matter as anionic surfactant, (MW 337) | 38.10% |
| Chloride ion (Cl⁻) content | 1.85% |
| Hardness | 9-10 |
| Grit | Absent |
| Mush | 8 g/50 cm² |

### Example 9

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 552 g) is added and agitation is continued for an additional one hour. This is followed by addition of the rest of the hydrogenated soyabean oil (410 g, 0.5 gmol) is added in two portions (205 g +205 g) and stirring of the mix is continued for additional two hours (1 h of stirring after each portion of oil) at 70-75° C. with continuous nitrogen purging. Acidity of the material is neutralized by addition of monoisopropanol amine (14 g, 0.18 gmol) to achieve pH of 5% dispersion between 5.0 to 6.0.

The ‘pH adjusted’ hot material is flaked (1080 g) and subsequently, it is kneaded with a chelating agent GLDA (L-Glutamic acid, N,N-diacetic acid, tetrasodium salt, 2.5 g, tocopherol, 1.25 g) and undecylenoyl glycine, 22.0 g, polyglyceryl-4 laurate, 44.0 g) in a sigma blender (with Z type sigma blades that rotate in opposite directions to each other) at 60-65° C. for 3 hour. The mass is finally refined using a triple roll mill and a duplex plodder (38-42° C.) to get the final billets for stamping.

TABLE 9
Analysis of the bar cake of Example 9:

| | |
|---|---|
| Moisture | 2.7% |
| pH (5% dispersion in water) | 5.38 |
| Active matter as anionic surfactant, (MW 337) | 38.50% |
| Chloride ion (Cl⁻) content | 1.76% |
| Hardness | 9-10 |
| Grit | Absent |
| Mush | 8 g/50 cm² |

### Example 10

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 552 g) is added and agitation is continued for an additional one hour. This is followed by addition of the rest of the hydrogenated soyabean oil (410 g, 0.5 gmol) is added in two portions (205 g +205 g) and stirring of the mix is continued for additional two hours (1 h stirring after each portion of oil) at 70-75° C. with continuous nitrogen purging. Acidity of the material is neutralized by addition of monoisopropanol amine (14 g, 0.18 gmol) to achieve pH of 5% dispersion between 5.0 to 6.0.

The ‘pH adjusted’ hot material is flaked (1076 g) and subsequently, it is blended with 1-hydroxyethane 1,1-diphosphonic acid disodium salt (Etidronic acid), 1.2 g, (0.1% of the total) propyl gallate, 1.2 g, 0.1% of the total) and actives (capryloyl glycine (20 g), sodium stearoyl lactylate 10 g), (glycerine 10 g), L-arginine (6.0 g) in a sigma blender (with Z type sigma blades that rotate in opposite directions to each other) at 60-65° C. for 3 hours. The mass is further refined using a triple roll mill and a duplex plodder (38-42° C.) to get the final billets for stamping.

TABLE 10
Analysis of the bar cake of Example 10:

| | |
|---|---|
| Moisture | 3.0% |
| pH (5% dispersion in water) | 5.73 |
| Active matter as anionic surfactant, (MW 337) | 36.6% |
| Chloride ion (Cl⁻) content | 1.58% |
| Hardness | 11-12 |
| Grit | Absent |
| Mush | 12 g/50 cm² |

### Example 11

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 552 g) is added and agitation is continued for an additional one hour. This is followed by addition of the rest of the hydrogenated soyabean oil (410 g, 0.5 gmol) is added in two portions (205 g +205 g) and stirring of the mix is continued for additional two hours (1h stirring after each portion of oil) at 70-75° C. with continuous nitrogen purging. Acidity of the material is neutralized by addition of L-lysine (28 g, 0.19 gmol) to achieve pH of 5% dispersion between 5.0 to 6.0.

The ‘pH adjusted’ hot material is flaked (1098 g) on a cold surface and subsequently, kneaded with water (88 ml) in a sigma blender (with ‘Z’ type sigma blades that rotate in opposite directions to each other) at 60-65° C. for 6 hours and finally refined using a triple roll mill and a duplex plodder (38-42° C.) to get the final billets for stamping.

TABLE 11
Analysis of the bar cake of Example 11:

| | |
|---|---|
| Moisture | 8.80% |
| pH (5% dispersion in water) | 5.85 |
| Active matter as anionic surfactant, (MW 337) | 36.80 |
| Chloride ion (Cl⁻) content | 1.05 |
| Hardness | 8-9 |
| Grit | Absent |
| Mush | 7.8 g/50 cm² |

### Example 12

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 552 g) is added and agitation is continued for an additional one hour. This is followed by addition of the rest of the hydrogenated soyabean oil (410 g, 0.5 gmol) is added in two portions (205 g+205 g) and stirring of the mix is continued for additional two hours (1h stirring after each portion of oil) at 70-75° C. with continuous nitrogen purging. Acidity of the material is neutralized by passing ammonia gas to achieve pH of 5% dispersion between 5.0 to 6.0.

The ‘pH adjusted’ hot material is flaked (1067g) on a cold surface and subsequently, kneaded with water (72 ml) in a sigma blender (with ‘Z’ type sigma blades that rotate in opposite directions to each other) at 60-65° C. for 6 hours and finally refined using a triple roll mill and a duplex plodder (38-42° C.) to get the final billets for stamping.

TABLE 12
Analysis of the bar cake of Example 12:

| | |
|---|---|
| Moisture | 6.5% |
| pH (5% dispersion in water) | 5.9. |
| Active matter as anionic surfactant, (MW 337) | 40.4 |
| Chloride ion (Cl⁻) content | 1.2 |
| Hardness | 10 |
| Grit | Absent |
| Mush | 7.95 gm/50 cm² |

### Example 13

To stirred lauroyl chloride (356 g, 1.6 gmol) at 35-40° C. and with nitrogen purging (bubbling through the reaction mass), sodium methyl isethionate (powder, 139g, 0.84 gmol) is added slowly and then the temperature is raised to 65-70° C. and stirring is continued for one hour. The hydrogen chloride gas (evolved as byproduct) is scrubbed in aqueous sodium hydroxide. To this mass, sodium isethionate (powder, 121 g, 0.8 gmol) is added and the temperature of the reaction mixture is raised to 70-75° C. and maintained for one hour for reacting the remainder lauroyl chloride. To this viscous slurry at 70-75° C., under continuous nitrogen purging to expel hydrogen chloride gas, part of hydrogenated soyabean oil (140 g, 0.17 gmol (25% of the total 550 g) is added and agitation is continued for an additional one hour. This is followed by addition of the rest of the hydrogenated soyabean oil (410 g, 0.5 gmol) in two portions (205 g +205 g) and stirring of the mix is continued for additional two hours (1h stirring after each portion of oil) at 70-75°° C. with continuous nitrogen purging. Acidity of the material is neutralized by addition of monoisopropanol amine (14 g, 0.18 gmol) to achieve pH of 5% dispersion between 5.0 to 6.0.

The ‘pH adjusted’ hot material is flaked (1085 g) on a cold surface and subsequently pulverized in a kitchen blender for 30 seconds. The powder is sieved using appropriate mesh to get 90% particles below particles size of 600μ.

TABLE 13
Analysis of the powdered solid cleansing
composition of Example 13:

| | |
|---|---|
| Moisture | 2.5% |
| pH (5% dispersion in water) | 5.16 |
| Active matter as anionic surfactant, (MW 337) | 39.8% |
| Chloride ion (Cl⁻) content | 1.2% |
| Lather on hand (1 g + 5 ml water) | Very creamy |
| Grit | Absent |

### Advantages of the Present Invention

1) The Process for making ‘grit-free’, ‘sulphate-free’, ‘soap-free’ solid cleansing bar using sodium O-acyl isethionates without having to resort to any emulsification with water and with non-ionic emulsifiers.

2) Solid cleansing compositions without any help of a binding agent or a plasticizer.

3) None of the steps of the process of present invention, including synthesis of sodium O-acyl isethionates, involves temperatures above 75° C. The gentle processing conditions avoid thermal degradation that is associated with high temperature reactions.

4) The process of the present invention requires low temperature that allows incorporation of all personal care actives in the final solid cleanser form.

5) The process of the present application does not involve any specialized equipment. Conventional reactor and conventional soap processing equipment are used in the current process.

6) The current process allows to create solid cleansers with skin pH.

7) The process of the present application is amenable to create solid cleanser with very incorporation (60% of total composition) of vegetable oil/s.

8) The solid cleanser obtained from the current process have the right balance of hardness and mush while delivering good performance on gentle cleansing with copious lather.

9) Solid cleansing composition is also formulated as ‘grit-free’ powder as where consumer takes the powder from a powder dispenser and adds water to generates thick creamy lather for washing of skin or hair and scalp.

We claim:

1. A process for preparing soap free, sulphate free and grit free solid cleansing composition comprising steps of:
A. preparing mixture of sodium O-acyl isethionate and sodium methyl O-acyl isethionate by reacting a part of acyl chloride with sodium methyl isethionate at 30° C. to 40° C., raising the temperature to 65° C. to 75° C., and adding sodium isethionate to allow consumption of remaining acyl chloride to obtain a reaction mixture;
B. adding hydrogenated triglyceride oil to the reaction mixture of step A to obtain a reaction mass;
C. adding a nitrogenous base to the reaction mass of step B to adjust the pH and afford a viscous reaction mass;
D. flaking the viscous reaction mass obtained in step C to afford flakes; and
E. kneading the flakes obtained in step D, refining and plodding it, wherein the pH in step C is adjusted in between 4 to 6; and
wherein the plodding temperature is between 38 to 42° C.

2. The process as claimed in claim 1, wherein the mixture of sodium O-acyl isethionate and sodium methyl O-acyl isethionate is selected from mixture of sodium cocoyl isethionate and sodium methyl cocoyl isethionate, mixture of sodium lauryl isethionate and sodium methyl lauryl isethionate or mixture thereof.

3. The process as claimed in claim 1, wherein the hydrogenated oil is selected from hydrogenated soyabean oil, hydrogenated sunflower oil, hydrogenated rapeseed oil, hydrogenated olive oil, hydrogenated coconut oil, hydrogenated palm oil, hydrogenated palm kernel oil or mixture thereof.

4. The process as claimed in claim 1, wherein the nitrogenous base is selected from monoisopropanol amine, triisopropanol amine, monoethanol amine, triethanol amine, basic amino acids, ammonia gas, inorganic base and mixture thereof.

5. A process for preparing soap free, sulphate free and grit free solid cleansing composition, the composition comprising:
a. at least 30%, by weight of total composition, a mixture of sodium O-acyl isethionate and sodium methyl O-acyl isethionate; and
b. at least 30%, by weight of total composition, one or more hydrogenated vegetable oil;
such that the ratio of sodium O-acyl isethionate and sodium methyl O-acyl isethionate is 4:6 to 6:4; and
such that melting point of the hydrogenated vegetable oil is at least 45° C.;
wherein the process comprises steps of:
A. preparing mixture of sodium O-acyl isethionate and sodium methyl O-acyl isethionate by reacting a part of acyl chloride with sodium methyl isethionate at 30° C. to 40° C., raising the temperature to 65° C. to 75° C., and adding sodium isethionate to allow consumption of remaining acyl chloride to obtain a reaction mixture;
B. adding hydrogenated triglyceride oil to the reaction mixture of step A to obtain a reaction mass;
C. adding a nitrogenous base to the reaction mass of step B to adjust the pH and afford a viscous reaction mass;
D. flaking the viscous reaction mass obtained in step C to afford flakes; and
E. kneading the flakes obtained in step D, refining and plodding it, wherein the pH in step C is adjusted in between 4 to 6; and
wherein the plodding temperature is between 38 to 42° C.

6. The process as claimed in claim 5, wherein the mixture of sodium O-acyl isethionate and sodium methyl O-acyl isethionate is selected from mixture of sodium cocoyl isethionate and sodium methyl cocoyl isethionate, mixture of sodium lauryl isethionate and sodium methyl lauryl isethionate or mixture thereof.

7. The process as claimed in claim 5, wherein the hydrogenated oil is selected from hydrogenated soyabean oil, hydrogenated sunflower oil, hydrogenated rapeseed oil, hydrogenated olive oil, hydrogenated coconut oil, hydrogenated palm oil, hydrogenated palm kernel oil or mixture thereof.

8. The process as claimed in claim 5, wherein the nitrogenous base is selected from monoisopropanol amine, triisopropanol amine, monoethanol amine, triethanol amine, basic amino acids, ammonia gas, inorganic base and mixture thereof.

9. The process as claimed in claim 5, wherein the composition further comprises additives selected from chelating agent, anti-oxidant, skin care active and hair care active.

10. The process as claimed in claim 9, wherein the additives are added at the kneading process of the step E.

11. A soap-free, sulphate-free and grit-free solid cleansing composition comprising:
a. at least 30%, by weight of total composition, a mixture of sodium O-acyl isethionate and sodium methyl O-acyl isethionate; and
b. at least 30%, by weight of total composition, one or more hydrogenated vegetable oil;
such that the ratio of sodium O-acyl isethionate and sodium methyl O-acyl isethionate is 4:6 to 6:4; and
such that melting point of the hydrogenated vegetable oil is at least 45° C.

12. The soap-free, sulphate-free and grit-free solid cleansing composition as claimed in claim 11, wherein the mixture of sodium O-acyl isethionate and sodium methyl O-acyl isethionate is selected from mixture of sodium cocoyl isethionate and sodium methyl cocoyl isethionate, mixture of sodium lauryl isethionate and sodium methyl lauryl isethionate, or mixture thereof.

13. The soap-free, sulphate-free and grit-free solid cleansing composition as claimed in claim 11, wherein the hydrogenated oil is selected from hydrogenated soyabean oil, hydrogenated sunflower oil, hydrogenated rapeseed oil, hydrogenated olive oil, hydrogenated coconut oil, hydrogenated palm oil, hydrogenated palm kernel oil or mixture thereof.

14. The soap-free, sulphate-free and grit-free solid cleansing composition as claimed in claim 11, wherein the composition further comprises additive selected from chelating agent, anti-oxidant, skin care active and hair care active.
